(19) United States
(12) Patent Application Publication
(10) Pub. No.: US 2006/0171678 A1
(43) Pub. Date: Aug. 3, 2006

(54) DVD reproducing apparatus

(75) Inventor: Tadashi Shimoguchi, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 11/344,110

(22) Filed: Feb. 1, 2006

(30) Foreign Application Priority Data
Feb. 2, 2005 (JP) P2005-025958

(51) Int. Cl. H04N 5/91

(52) U.S. Cl. 386/95

(57) ABSTRACT

A DVD reproducing apparatus includes a key information storing unit that stores key information for decoding and reproducing a coded data recorded in the DVD, a reproducing unit that reproduces the data recorded in the DVD, a coding determining unit that determines whether the data recorded in the DVD is coded data in reproducing the data recorded in the DVD by the reproducing unit, an acquiring unit that acquires key information for decoding and reproducing the coded data by searching the key information storing unit when it is determined that the data recorded in the DVD is coded data, a decoding unit that decodes the coded data recorded in the DVD by using the key information, and a display controlling unit that displays a predetermined display indicating the coded data at a predetermined display section when the coded data recorded in the DVD which was decoded is reproduced.

### BACKGROUND OF THE INVENTION

1. Field of the Invention

The present invention relates to a DVD reproducing apparatus.

2. Description of the Related Art

Digital contents of music, picture image, image and the like are not deteriorated even when the digital contents are copied and therefore, the digital contents are frequently copied illegally. Hence, in a background art, in order to prevent illegal copying, there has been developed various copyright protecting technologies of digital contents such that digital contents are coded or the like and distributed or the like. However, when digital contents are simply coded and the contents are not displayed at all, a user loses interest to deteriorate to promote to distribute digital contents. Hence, in a system of distributing the contents, there is known a distribution system stimulating interest of a user by providing a user with partially coded digital contents and displaying contents partially (See, e.g. JP-A-2002-158654).

Further, there is known a method of synthesizing music data constituting digital contents with extra data of advertising sound or the like to provide to a user, coding synthesized data and decoding synthesized data only by a user purchasing legal key information to be able to cancel extra data (See, e.g. JP-A-2000-123481).

Meanwhile, recording of digital contents to DVD (Digital Versatile Disc) is carried out by two standards of a video mode and a DVD-VR (DVD-Video Recording) mode. Further, decoding of digital contents decoded by the DVD-VR mode is carried out by a copyright protecting technology referred to as CPRM (Content Protection for Recordable Media).

When DVD recorded with digital contents coded by CPRM by the DVD-VR mode is reproduced by a DVD reproducing apparatus of a CPRM noncorresponding type, a screen becomes full of block noise and a system decoder is hung up. In order to prevent the drawback, normally, there is carried out an operation of stopping to reproduce a portion coded by CPRM, or skipping the portion coded by CPRM or the like.

However, when the portion coded by CPRM is stopped to reproduce, in the case in which there is a portion of data thereafter which is not coded by CPRM, a portion which is not coded by the CPRM cannot be seen or heard. Further, when the portion coded by CPRM is skipped, actually, data of skipped portion cannot be acquired and therefore, there poses a problem that normal operation cannot be carried out such that reproducing information of a reproducing time period or the like cannot accurately be acquired, time search or FF/FR search processing cannot be carried out, resume information cannot be acquired or the like. The above-described invention of JP-A-2002-158654 and JP-A-2000-123481 are technologies for coding digital contents to provide to a user and therefore, the above-described problem posed when coded digital contents are reproduced cannot be resolved.

It is a problem of the invention to provide a DVD reproducing apparatus capable of reproducing coded data by an operation similar to that for uncoded data and capable of protecting copyright.

### SUMMARY OF THE INVENTION

The invention according to a first aspect is characterized in including key information storing means for storing second key information adapted to first key information stored in a DVD for decoding and reproducing a coded data stored in the DVD, reproducing means for reproducing the data recorded in the DVD, coding determining means for determining whether the data recorded in the DVD is the coded data in reproducing the data recorded in the DVD by the reproducing means, acquiring means for acquiring the second key information adapted to the first key information stored to the DVD for decoding and reproducing the coded data by searching the key information storing means when it is determined that the data recorded in the DVD is the coded data by the coding determining means, decoding means for decoding the coded data recorded in the DVD by generating decoding key information from the first key information and the second key information acquired by the acquiring means, and display controlling means for executing a control of displaying a black screen or a control of displaying a predetermined warning sentence on a screen at a predetermined display section when the coded data recorded in the DVD which has been decoded by the decoding means is reproduced by the reproducing means, wherein the coded data is a data coded by CPRM (Content Protection for Recordable Media).

The invention according to a second aspect is characterized in including key information storing means for storing key information for decoding and reproducing a coded data recorded in the DVD, reproducing means for reproducing the data recorded in the DVD, coding determining means for determining whether the data recorded in the DVD is the coded data in reproducing the data recorded in the DVD by the reproducing means, acquiring means for acquiring the key information for decoding and reproducing the coded data by searching the key information storing means when it is determined that the data recorded in the DVD is the coded data by the coding determining means, decoding means for decoding the coded data recorded in the DVD by using the key information acquired by the acquiring means, and display controlling means for displaying a predetermined display indicating the coded data at a predetermined display section when the coded data recorded in the DVD which has been decoded by the decoding means is reproduced by the reproducing means.

The invention according to a third aspect is characterized in including key information storing means for storing second key information adapted to first key information stored in a DVD for decoding and reproducing a coded data stored in the DVD, reproducing means for reproducing the data recorded in the DVD, coding determining means for determining whether the data recorded in the DVD is the coded data in reproducing the data recorded in the DVD by the reproducing means, acquiring means for acquiring the second key information adapted to the first key information stored in the DVD for decoding and reproducing the coded data by searching the key information storing means when it is determined that the data recorded in the DVD is the coded data by the coding determining means, decoding means for decoding the coded data recorded in the DVD by generating decoding key information from the first key information and the second key information acquired by the acquiring means, and display controlling means for displaying a predetermined display indicating the coded data at a predetermined display section when the coded data recorded in the DVD which has been decoded by the decoding means is reproduced by the reproducing means.

The invention according to a fourth aspect is characterized in that the coded data is a data coded by CPRM in the DVD reproducing apparatus according to the third aspect.

The invention according to a fifth aspect is characterized in that the display controlling means executes a control of displaying a black screen or a control for displaying a predetermined warning sentence on a screen at the display section in the DVD reproducing apparatus according to any one of the second to fourth aspects.

According to the first aspect of the invention, by the key information storing means, the second key information adapted to the first key information stored in the DVD is stored by the reproducing means, data recorded in the DVD is reproduced, in reproducing the data recorded in the DVD by the reproducing means, by the coding determining means, it is determined whether the data recorded in the DVD is the coded data by CPRM, when it is determined that the data recorded in the DVD is the coded data by CPRM by the decoding determining means, by the acquiring means, the key information storing means is searched, the second key information adapted to the first key information stored in the DVD for decoding and reproducing the coded data is acquired, by the decoding means, the decoding key information is generated from the first key information and the second key information acquired by the acquiring means, the coded data recorded in the DVD is decoded, when the coded data recorded in the DVD decoded by the decoding means is reproduced by the reproducing means, by the display controlling means, the control of displaying the black screen or the control of displaying the predetermined warning sentence on the screen at the predetermined display section is executed and therefore, the data coded by CPRM can be decoded and a normal operation can be executed even when the DVD recorded with the coded data is reproduced. Further, in reproducing the coded data which has been decoded, the black screen or the predetermined warning sentence is displayed at the display section and therefore, even when the coded portion is decoded, the copyright can be protected.

Further, by the display controlling means, the control of displaying the black screen or the control of displaying the predetermined warning sentence on the screen at the predetermined display section is carried out and therefore, a display indicating the coded data can be simplified.

According to the second aspect of the invention, by the key information storing means, the key information for decoding and reproducing the coded data stored in the DVD is stored, by the reproducing means, the data recorded in the DVD is reproduced, in reproducing the data recorded in the DVD by the reproducing means, by the coding determining means, it is determined whether the data recorded in the DVD is the coded data, when it is determined that the data recorded in the DVD is the coded data, by the acquiring means, the key information storing means is searched, the key information for decoding and reproducing the coded data is acquired, by the decoding means, the key information acquired by the acquiring means is used, the coded data recorded in the DVD is decoded, when the coded data recorded in the DVD which has been decoded by the decoding means is reproduced by the reproducing means, by the display controlling means, the predetermined display indicating the coded data is displayed at the predetermined display section and therefore, the coded data can be decoded, and even when the DVD recorded with the coded data is reproduced, the normal operation can be executed. Further, in reproducing the coded data which has been decoded, the predetermined display indicating the coded data is displayed at the display section and therefore, even when the coded portion is decoded, the copyright can be protected.

According to the third aspect of the invention, by the key information storing means, the second key information adapted to the first key information stored in the DVD is stored, by the reproducing means, data recorded in the DVD is reproduced, in reproducing the data recorded in the DVD, by the coding determining means, it is determined whether the data recorded in the DVD is the coded data, when it is determined that the data recorded in the DVD is the coded data by the coding determining means, by the acquiring means, the key information storing means is searched, the second key information adapted to the first key information stored in the DVD for decoding and reproducing the coded data is acquired, by the decoding means, the decoding key information is generated by the first key information and the second key information acquired by the acquiring means, the coded data recorded in the DVD is decoded, when the coded data recorded in the DVD which has been decoded by the decoding means is reproduced by the reproducing means, by the display controlling means, the predetermined display indicating the coded data is displayed at the predetermined display section and therefore, even when two pieces of the key information of the first key information and the second key information are needed for decoding the coded data, the coded data can be decoded, and the normal operation can be executed even when the DVD recorded with the coded data is reproduced. Further, in reproducing the coded data which has been decoded, the predetermined display indicating the coded data is displayed at the display section and therefore, even when the coded portion is decoded, the copyright can be protected.

According to the fourth aspect of the invention, an effect similar to that of the invention according to the third aspect can naturally be achieved, particularly, the data coded by CPRM can be decoded, and even when the DVD recorded with the data coded by CPRM is reproduced, the normal operation can be executed.

According to the fifth aspect of the invention, an effect similar to that of the invention according to any one of the second to fourth aspects can naturally be achieved, particularly, the control of displaying the black screen or the control of displaying the predetermined warning sentence on the screen at the predetermined display section is carried out and therefore, the display indicating the coded data can be simplified.

### BRIEF DESCRIPTION OF THE DRAWINGS

FIG. 1 is a diagram showing a hierarchical structure of data recorded in DVD according to the invention;

FIG. 2 is a block diagram showing a constitution of the DVD reproducing apparatus according to the invention;

FIG. 3 is a diagram showing a constitution of a system microcomputer according to the invention; and

FIG. 4 is a flowchart for explaining operation of the DVD reproducing apparatus according to the invention.

### DETAILED DESCRIPTION OF THE INVENTION

The best mode for carrying out a DVD reproducing apparatus according to the invention will be explained in details in reference to the drawings as follows.

<Hierarchical Structure of Data of DVD>

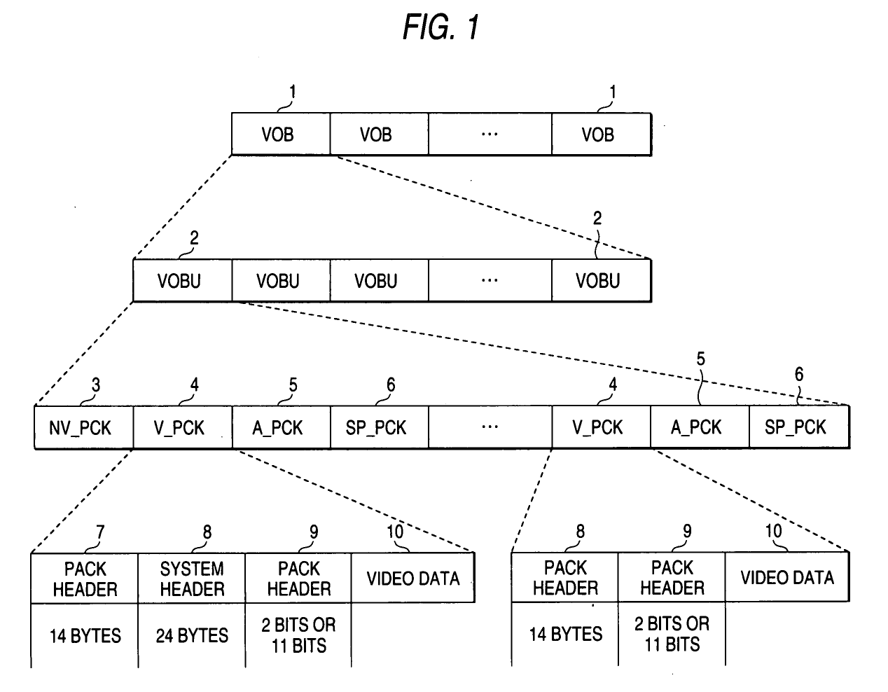

FIG. 1 shows a hierarchical structure of data recorded in DVD-VR mode. Data recorded to DVD in DVD-VR mode is constituted by including a plurality of VOB (video object) 1 or the like.

As shown by FIG. 1, VOB1 is constituted by a plurality of VOBU (video object unit) 2.

Further, VOBU2 is constituted by NV_PCK (navigation pack) 3, V_PCK (video pack) 4, A_PCK (audio pack) 5, and SP_PCK (subpicture pack) 6.

One NV_PCK3 is necessarily included in one VOBU2 and stored with address data of V_PCK4, A_PCK5, SP_PCK6 and additional information for smoothly carrying out processings of normal reproduction and special reproduction.

Pluralities of V_PCK4, A_PCK5, SP_PCK6 are included in VOBU2. Further, V_PCK4, A_PCK5, SP_PCK6 respectively compress and code individually data of video data 10, voice data, a caption or the like to store.

Front V_PCK4 included in VOBU2 is stored with data in an order of first pack header 7 including 14 bytes, system header 8 including 24 bytes, second pack header 9 including 2 bits or 11 bits, video data 10. Further, second pack header 9 includes 11 bits when data recorded in DVD-VR mode is coded by CPRM (Content Protection for Recordable Media) and includes 2 bits when not coded.

Here, CPRM is a copyright protecting technology. CPRM uses two pieces of key information as key information necessary for decoding coded data. Key information of a disc as first key information is recorded in DVD when data recorded to DVD in DVD-VR mode is coded. In DVD reproducing apparatus, there are CPRM corresponding type and CPRM noncorresponding type, and DVD reproducing apparatus of CPRM corresponding type is provided with device key information as second key information adapted to key information of a disc. Further, in DVD reproducing apparatus of CPRM corresponding type, decoding key information is generated from the key information of a disc and device key information adapted to the key information of the disc and data coded by CPRM by using the decoding key information.

Further, V_PCK4 and A_PCK5 and SP_PCK6 other than front V_PCK4 included in VOBU2 are stored with data in an order of first pack header 7 including 14 bytes, second pack header 9 including 2 bits or 11 bits, video data 10. Further, similar to the case of front V_PCK4, second pack header 9 includes 11 bits when data recorded in DVD-VR mode is coded by CPRM and includes 2 bits when not decoded.

<Constitution of DVD Reproducing Apparatus>

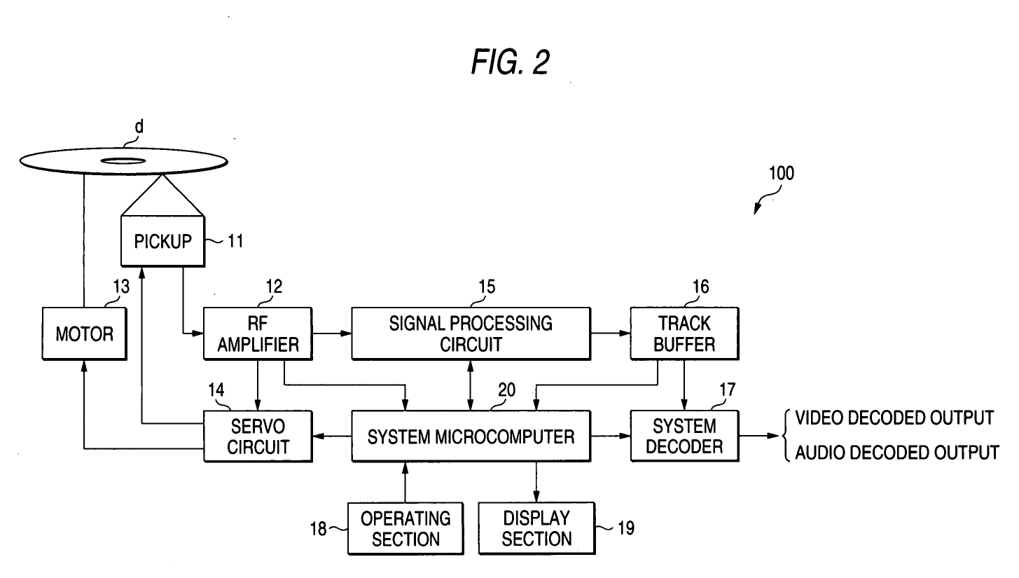

Next, a constitution of a DVD reproducing apparatus 100 according to the invention will be explained in reference to FIG. 2. According to the embodiment, an explanation will be given by exemplifying the DVD reproducing apparatus 100 of a CPRM noncorresponding type as the DVD reproducing apparatus 100 according to the invention.

As shown by FIG. 2, the DVD reproducing apparatus 100 is constituted by including a pickup 11, an RF amplifier 12, a motor 13, a servo circuit 14, a signal processing circuit 15, a track buffer 16, a system decoder 17, an operating section 18, a display section 19, a system microcomputer 20 and the like.

The pickup 11 irradiates a predetermined wave length of laser light to a recording face of a disc d and receives reflected light thereof to convert into an electric signal (reflected light detecting signal). Further, the pickup 11 outputs the reflected light detecting signal to the RF amplifier 12. Further, the pickup 11 is supported by a predetermined guide shaft or the like movably in a diameter direction of the disc d so as to be able to pertinently read object data from the disc d.

The RF amplifier 12 generates an RF signal, a tracking signal, a focusing signal and the like from the reflected light detecting signal outputted from the pickup 11. Further, the RF amplifier 12 generates a binarized signal constituted by subjecting the RF signal to data slicing. The RF amplifier 12 outputs the generated tracking signal or the like to the servo circuit 14 and outputs the generated binarized signal to the signal processing circuit 15 as a reproducing signal.

The motor 13 includes a spindle motor or the like for rotating a predetermined turn table mounted with the disc d. The motor 13 is controlled by the servo circuit 14 for moving to rotate the disc d such that, for example, a line speed thereof becomes constant.

The servo circuit 14 controls to drive the motor 13 to drive to rotate by a predetermined rotational speed. Further, the servo circuit 14 controls to drive a sled motor (not illustrated) by the tracking signal or the like outputted from the RF amplifier 12 to move the pickup 11 pertinently in the diameter direction of the disc d.

The signal processing circuit 15 decodes the reproducing signal outputted from the RF amplifier 12 to subject to an error correction processing or the like. The signal processing circuit 15 outputs decoded data provided by the decoding or the like successively to the track buffer 16.

The track buffer 16 includes a predetermined capacity of RAM (Random Access Memory) (not illustrated) or the like for successively storing the decoded data outputted from the signal processing circuit 15. Further, the decoded data stored to the track buffer 16 is successively outputted to the system decoder 17.

The system decoder 17 decodes the decoded data outputted from the track buffer 16 to generate image data and voice data or the like. The system decoder 17 outputs the generated image data and the generated voice data or the like to the predetermined AV amplifier (not illustrated).

The operating section 18 is constituted by including various operation keys (not illustrated) provided at, for example, a remote controller (not illustrated) or a main body of the DVD reproducing apparatus 100.

The display section 19 includes an LCD (Liquid Crystal Display) panel or the like for displaying a situation of operating the DVD reproducing apparatus 100 or an image by reproducing DVD or the like.

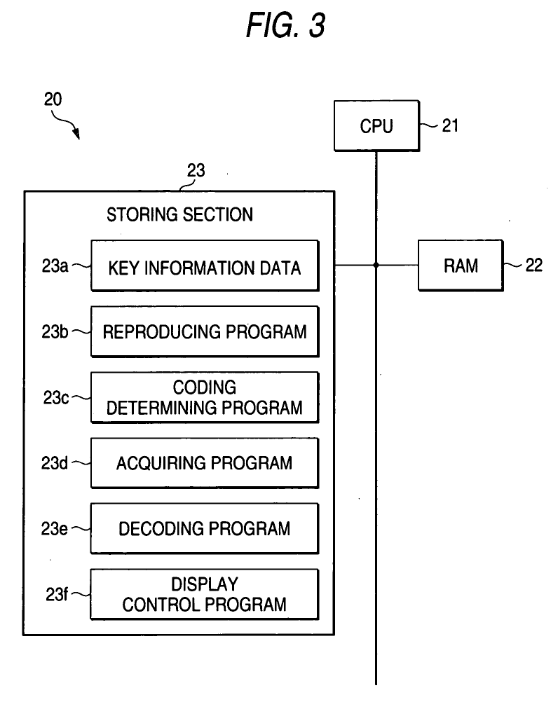

The system microcomputer 20 is constituted by including CPU (Central Processing Unit) 21, RAM 22, a storing section 23 or the like as shown by, for example, FIG. 3.

CPU 21 controls a total of the DVD reproducing apparatus 100 by reading a processing program or the like stored to the storing section 23 to expand to RAM 22 to execute.

RAM 22 expands the processing program or the like executed by CPU 21 to a program storing region at inside of RAM 22 and stores a processing result or the like produced in executing the processing program to a work area.

The storing section 23 includes a record medium (not illustrated) previously stored with programs and data and the like and the record medium is constituted by a semiconductor memory or the like. Further, the storing section 23 is stored with various data, various processing programs, data or the like processed by executing the programs for realizing a function of CPU 21 for controlling the total of the DVD reproducing apparatus 100. Further specifically, the storing section 23 is stored with key information data 23a, a reproducing program 23b, a decoding determining program 23c, an acquiring program 23d, a decoding program 23e, a display control program 23f or the like as shown by, for example, FIG. 3.

The key information data 23a is device key information on a side of the DVD reproducing apparatus 100 adapted to key information of the disc necessary for decoding coded data. There are a plurality of kinds of key information of the disc and there are also a plurality of kinds of the device key information in order to be adapted to respectives of the key information of the disc. Therefore, the storing section 23 stored with the key information data 23a functions as key information storing means.

Further, although the DVD reproducing apparatus 100 according to the invention is of the CPRM noncorresponding type, different from a normal DVD reproducing apparatus of a CPRM noncorresponding type, the DVD reproducing apparatus 100 is constituted by including the key information data 23a which is the device key information.

The reproducing program 23b is, for example, a program for making CPU 21 realize a function of reading the disc d to reproduce by controlling the pickup 11, the servo circuit 14 or the like. Further specifically, the reproducing program 23b is a program for making CPU 21 realize a function of searching object data constituting an object to be read by controlling the pickup 11, the servo circuit 14, reading the searched object data from the disc d, generating the reproducing signal from the read object data, executing decoding and error correcting processings or the like by controlling the signal processing circuit 15, storing the decoded data to the track buffer 16 and decoding the stored decoded data by controlling the system decoder 17 to successively reproduce the provided image data and voice data. CPU 21 functions as reproducing means by executing the reproducing program 23b.

The coding determining program 23c is, for example, a program for realizing a function of determining whether data of V_PCK4, A_PCK5, SP_PCK6 are coded based on sizes of data of the second pack header 9 of V_PCK4, A_PCK5, SP_PCK6 in CPU 21. Further specifically, the coding determining program 23c makes CPU 21 read object data from the disc d by controlling the pickup 11, the servo circuit 14 and the like, determines that the data are not coded when the sizes of data of the second pack header 9 of V_PCK4, A_PCK5, SP_PCK6 of the object data are constituted by 2 bits and determines that the data are coded when the sizes are constituted by 11 bits. CPU 21 functions as coding determining means by executing the coding determining program 23c.

The acquiring program 23d is, for example, a program for realizing a function of acquiring the device key information adapted to the key information of the disc by searching the key information data 23a at CPU 21. Further specifically, the acquiring program 23d is a program of realizing a function of acquiring device key information adapted to the key information of the disc for decoding the coded data by searching the key information data 23a when it is determined that data recorded to DVD is coded at CPU 21. CPU 21 functions as acquiring means by executing the acquiring program 23d.

The decoding program 23e is, for example, a program for realizing a function of generating decoding key information from the key information of the disc and acquired device key information and decoding the coded data by using the decoding key information at CPU 21. CPU 21 functions as decoding means by executing the decoding program 23e.

The display control program 23f is, for example, a program for realizing a function of displaying a black screen or a predetermined warning sentence indicating the coded data by controlling the display section 19 when the coded data is decoded at CPU 21. CPU 21 functions as display controlling mean by executing the display control program 23f.

<Operation of DVD Reproducing Apparatus>

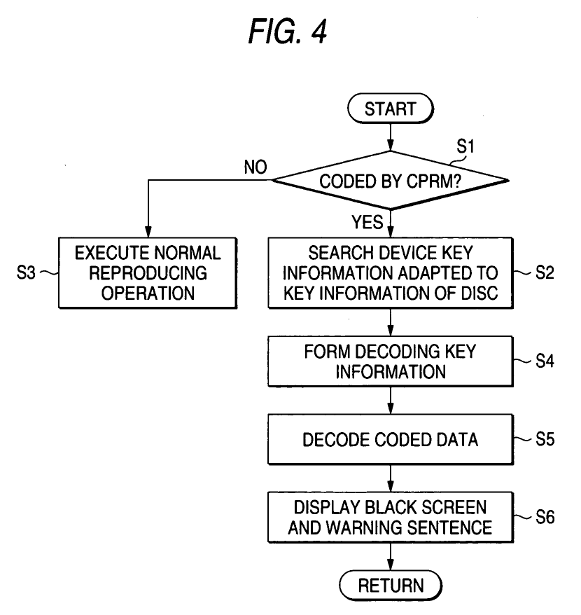

Next, operation of the DVD reproducing apparatus 100 having the above-described constitution will be explained in reference to a flowchart shown in FIG. 4.

First, when the operating section 18 is operated by a user and an instruction of reproducing DVD is inputted, CPU 21 determines whether data recorded in DVD is coded by executing the coding determining program 23c (step S1).

When it is determined that the data recorded in DVD is not coded at step S1 (step S1; No), CPU 21 normally reproduces DVD by executing the reproducing program 23b (step S3).

When it is determined that data recorded in DVD is coded at step S1 (step S1; Yes), CPU 21 searches the key information data 23a and acquires the device key information adapted to the key information of the disc for decoding the coded data by searching the key information data 23a by executing the acquiring program 23d (step S2).

Next, CPU 21 generates the decoding key information from the key information of the disc and the device key information acquired at step S2 by executing the decoding program 23e (step S4).

Successively, CPU 21 decodes the coded data by using the generated decoding key information (step S5).

Next, CPU 21 reproduces the coded data decoded by step S5 by executing the reproducing program 23b and displays a black screen or a predetermined warning sentence indicating the coded data by controlling the display section 19 (step S6).

According to the DVD reproducing apparatus 100 explained above, CPU 21 reproduces data recorded in DVD by executing the reproducing program 23b, determines whether the data recorded in DVD is data decoded by CPRM by executing the decoding determining program 23c in reproducing the data recorded in DVD, when it is determined that the data recorded in DVD is the data coded by CPRM, searches the key information data 23a by executing the acquiring program 23d, acquires the device key information adapted to the key information of the disc stored in DVD for decoding and reproducing the coded data, generates the decoding key information from the key information of the disc and the device key information by executing the decoding program 23e, decodes the coded data recorded in DVD, executes the display control program 23f in reproducing the coded data recorded in DVD which has been decoded by executing the reproducing program 23b, thereby, executes the control of displaying the black screen or the control of displaying the predetermined warning sentence on the screen and therefore, even in the case of the DVD reproducing apparatus 100 of the CPRM noncorresponding type, the data coded by CPRM can be decoded and normal operation can be executed even when DVD recorded with the coded data is reproduced. Further, the black screen or the predetermined warning sentence is displayed at the display section 19 and therefore, even when the coded section is decoded, the copyright can be protected. Therefore, in reproducing the data decoded by CPRM, the operation similar to that for the data which is not coded can be carried out and the copyright can be protected.

Further, CPU 21 displays the black screen or the predetermined warning sentence on the screen of the display section 19 by executing the display control program 23f and therefore, the display indicating the coded data can be simplified.

Further, although according to the embodiment of the invention, an explanation has been given of the case of coding the data recorded in DVD by CPRM, the invention is not limited thereto. Further, a single piece of the key information necessary for decoding the coded data will do and in that case, the key information is the device key information provided to the DVD reproducing apparatus 100.

Further, although according to the embodiment of the invention, the black screen or the warning sentence indicating the coded data is displayed in the display section 19, any display will do so far as the display is a display indicating the coded data. For example, the display may be a display in which the image data reproduced by decoding the coded data recorded in DVD is mosaiced.

Further, although according to the embodiment, the DVD reproducing apparatus 100 provided with the display section 19 has been exemplified, the display section 19 may not be necessarily provided but other display apparatus of a liquid crystal display device or the like may be connected to the DVD reproducing apparatus 100.

What is claimed is:

1. A DVD reproducing apparatus comprising:
a key information storing unit that stores second key information adapted to first key information stored in a DVD for decoding and reproducing a coded data recorded in the DVD;
a reproducing unit that reproduces data recorded in the DVD;
a coding determining unit that determines whether the data recorded in the DVD is coded data in reproducing the data recorded in the DVD by the reproducing unit;
an acquiring unit that acquires second key information adapted to the first key information stored in the DVD for decoding and reproducing the coded data by searching the key information storing unit when it is determined that the data recorded in the DVD is coded data by the coding determining unit;
a decoding unit that decodes the coded data recorded in the DVD by generating decoding key information from the first key information and the second key information acquired by the acquiring unit; and
a display controlling unit that executes a control of displaying a black screen or a control of displaying a predetermined warning sentence on a screen at a predetermined display section when the coded data recorded in the DVD which was decoded by the decoding unit is reproduced by the reproducing unit;
wherein the coded data is a data coded by CPRM (Content Protection for Recordable Media).

2. A DVD reproducing apparatus comprising:
a key information storing unit that stores key information for decoding and reproducing a coded data recorded in the DVD;
a reproducing unit that reproduces the data recorded in the DVD;
a coding determining unit that determines whether the data recorded in the DVD is coded data in reproducing the data recorded in the DVD by the reproducing unit;
an acquiring unit that acquires key information for decoding and reproducing the coded data by searching the key information storing unit when it is determined that the data recorded in the DVD is coded data by the coding determining unit;
a decoding unit that decodes the coded data recorded in the DVD by using the key information acquired by the acquiring unit; and
a display controlling unit that displays a predetermined display indicating the coded data at a predetermined display section when the coded data recorded in the DVD which was decoded by the decoding unit is reproduced by the reproducing unit.

3. A DVD reproducing apparatus comprising:
a key information storing unit that stores second key information adapted to first key information stored in a DVD for decoding and reproducing a coded data stored in the DVD;
a reproducing unit that reproduces the data recorded in the DVD;
a coding determining unit that determines whether the data recorded in the DVD is coded data in reproducing the data recorded in the DVD by the reproducing unit;
an acquiring unit that acquires second key information adapted to the first key information stored in the DVD for decoding and reproducing the coded data by searching the key information storing unit when it is determined that the data recorded in the DVD is coded data by the coding determining unit;
a decoding unit that decodes the coded data recorded in the DVD by generating decoding key information from the first key information and the second key information acquired by the acquiring unit; and
a display controlling unit that displays a predetermined display indicating the coded data at a predetermined display section when the coded data recorded in the DVD which was decoded by the decoding unit is reproduced by the reproducing unit.

4. The DVD reproducing apparatus according to claim 3,
wherein the coded data is a data coded by CPRM.

5. The DVD reproducing apparatus according to claim 2,
wherein the display controlling unit executes a control of displaying a black screen or a control for displaying a predetermined warning sentence on a screen at the display section.

6. The DVD reproducing apparatus according to claim 3,
wherein the display controlling unit executes a control of displaying a black screen or a control for displaying a predetermined warning sentence on a screen at the display section.

7. The DVD reproducing apparatus according to claim 4,
wherein the display controlling unit executes a control of displaying a black screen or a control for displaying a predetermined warning sentence on a screen at the display section.
